(19) United States
(12) Patent Application Publication
(10) Pub. No.: US 2010/0253778 A1
(43) Pub. Date: Oct. 7, 2010

(54) MEDIA DISPLAYING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/499,104

(22) Filed: Jul. 8, 2009

(30) Foreign Application Priority Data
Apr. 3, 2009 (CN) 200910301348.3

(51) Int. Cl. H04N 7/18; H04N 5/76

(52) U.S. Cl. 348/143; 348/231.2; 348/E05.031; 348/E07.085

(57) ABSTRACT

A media displaying system includes a displaying unit, an image capture unit, a processing unit, and a storage system. The image capture unit captures a number of viewer images. The system examines the number of viewer images to find faces in each viewer image, identifies characteristics of each found face in each viewer image, determines information about viewers accordingly, selects media content from the storage system according to information about the viewers. The displaying unit displays the selected media content.

### BACKGROUND

1. Technical Field

The present disclosure relates to a media displaying system and a media displaying method.

2. Description of Related Art

Outdoor media, such as electronic billboards may advertise various goods to consumers who view the electronic billboards. Sometimes, operators need to obtain data from the outdoor media remotely, such as whether people are attracted by visual and acoustic effects of the outdoor media, and differences between attitudes toward the media contents of different groups, and demographic data such as audience members' ages and gender.

### BRIEF DESCRIPTION OF THE DRAWINGS

FIG. 1 is a schematic block diagram of an exemplary embodiment of a media displaying system, the media displaying system includes a storage system.

FIG. 2 is a schematic block diagram of the storage system of FIG. 1.

FIG. 3 is a schematic block diagram of an exemplary embodiment of a video monitoring system.

FIG. 4 is a flowchart of an exemplary embodiment of a media displaying method.

### DETAILED DESCRIPTION

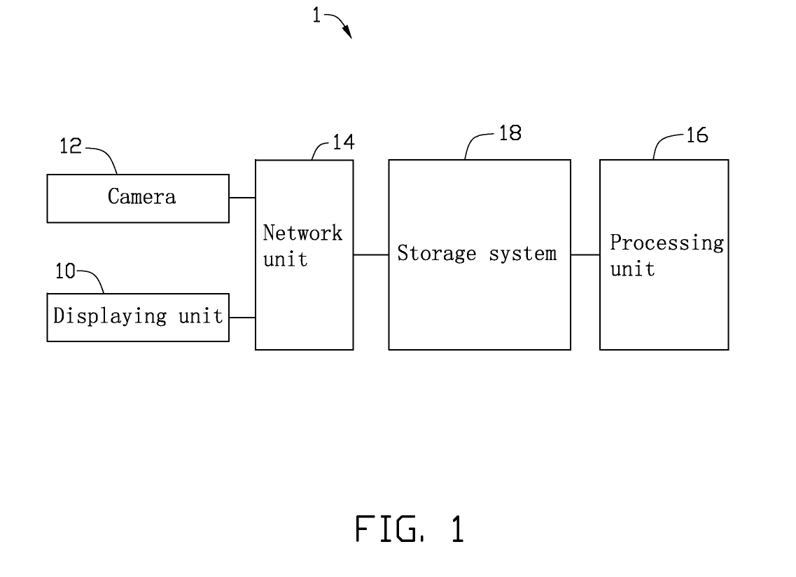

Referring to FIG. 1, an exemplary embodiment of a media displaying system 1 includes a displaying unit 10, such as an electronic billboard, an image capture unit, such as a camera 12, a network unit 14, a processing unit 16, and a storage system 18. The storage system 18 is coupled to the displaying unit 10 and the camera 12 via the network unit 14. The processing unit 16 is coupled to the storage system 18.

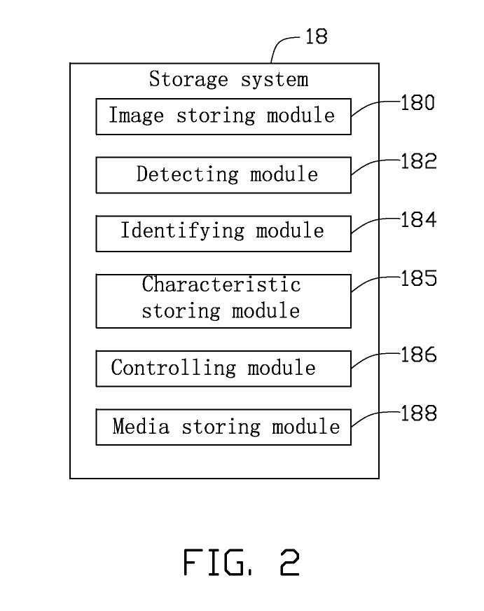

Referring to FIG. 2, the storage system 18 includes an image storing module 180, a detecting module 182, an identifying module 184, a characteristic storing module 185, a controlling module 186, and a media storing module 188. The detecting module 182, the identifying module 184, and the controlling module 186 may include one or more computerized instructions and are executed by the processing unit 16.

The camera 12 is disposed on the displaying unit 10 to capture a plurality of viewer images. Viewer images are one or more persons who are viewing the media displaying system 1. The plurality of viewer images are stored in the image storing module 180 via the network unit 14. The network unit 14 may include communication tools, such as a router, so as to allow the camera 12 to communicate with the storage system 18. As a result, the plurality of images from the camera 12 can be transmitted to the storage system 18 via the network unit 14.

The detecting module 182 examines the plurality of viewer images stored in the image storing module 180 to find faces in the viewer images and identify characteristics of the found faces. It can be understood that the detecting module 182 uses well known facial recognition technology to find the faces in the viewer images and identify characteristics of the found face.

The characteristic storing module 185 stores a plurality of face characteristics, such as facial features on the faces, and information associated with those face characteristics, such as age and gender using known algorithms. For example, users may define different facial features correspond to different ages or different gender. It can be understood that which facial features correspond to male or female, and young people or old people, are well known technology.

The identifying unit 184 determines information about the viewers, such as gender or age, according to the characteristic storing module 185 and the detecting module 182. For example, the characteristic storing module 185 may characterize that a first facial feature on a face corresponds to a man who is about 20-25 years old. As a result, the identifying unit 184 identifies viewer information about the face, such as the person being male and about 20-25 years old.

The media storing module 188 stores a plurality of different media content, such as advertisements for toys and razors, corresponding to viewers with different information. For example, advertisements for toys may correspond to children viewers. Advertisements for razors may correspond to male viewers.

The controlling module 186 is operable to select the media content according to the information about the viewers, and to transmit the selected media content to the displaying unit 10 via the network unit 14. The displaying unit 10 is operable to display the media content in the media module 188 according to the controlling module 186. For example, if viewers are children, media content about toys can be selected. If viewers are men, media content about razors can be selected.

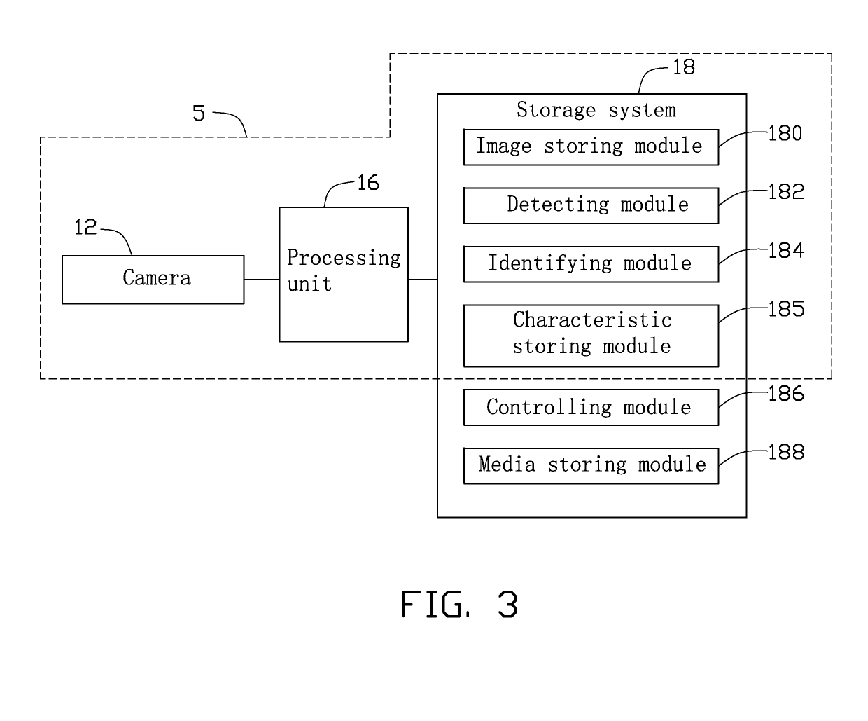

Referring to FIG. 3, it can be understood that the camera 12, the processing unit 16, the image storing module 180, the detecting module 182, the identifying module 184, and the characteristic storing module 185 can form a video monitoring system 5. The video monitoring system 5 is operable to collect information about the viewers, such as age and gender, at different times and different positions. The information about the viewers can be fed back to users.

In other embodiments, the network unit 14 can be omitted. As a result, the displaying unit 10 and the camera 12 are coupled to the storage system 18 directly. The processing unit 16 and the storage system 18 are located inside of the displaying unit 10.

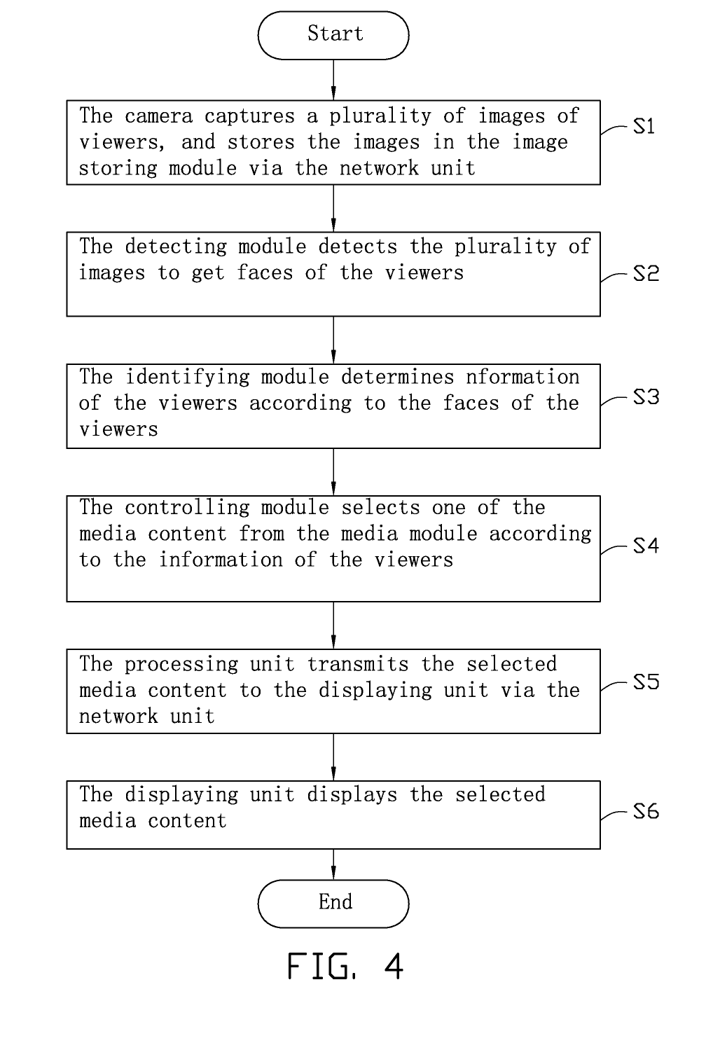

Referring to FIG. 4, an exemplary embodiment of a media displaying method includes the following steps.

In step S1, the camera 12 captures a plurality of viewer images, and stores the plurality of viewer images in the image storing module 180 via the network unit 14.

In step S2, the detecting module 182 examines each of the plurality of viewer images to find faces in each viewer image, and identifies characteristics of each found faces. It can be understood that the detecting module 182 uses well known facial recognition technology to find the faces in the viewer images and identify characteristics of the found faces. The characteristics of the found faces may include facial features.

In step S3, the identifying module 184 determines information, such as age and gender, about the faces according to the characteristic storing module 185 and the detecting module 182. The characteristic storing module 185 stores a plurality of face characteristics, such as facial features on the faces, and information associated with those face characteristics, such as age and gender using known algorithms. For example, the plurality of face characteristics may include a first characteristic and a second characteristic. The first characteristic corresponds to men, and the second characteristic corresponds to women.

In step S4, the controlling module 186 selects media content from the media module 188 according to viewer information from the identifying unit 184. For example, if the viewers are men, the controlling module 186 selects the advertisements about razors.

In step S5, the processing unit 16 transmits the selected media content to the displaying unit 10 via the network unit 14.

In step S6, the displaying unit 10 displays the selected media content.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A media displaying system comprising:
an image capture unit to capture a plurality of viewer images;
a processing unit;
a storage system connected to the processing unit and storing one or more programs to be executed by the processing unit, wherein the storage system comprises:
an image storing module to store the plurality of viewer images from the image capture unit;
a detecting module to examine each of the plurality of viewer images to find faces in each viewer image and identify characteristics of each found face;
a characteristic storing module to store a plurality of face characteristics and information associated with the plurality of face characteristics;
an identifying module to determine information about viewers according to the characteristic storing module and the detecting module;
a media storing module to store different media content corresponding to the information about the viewers; and
a controlling module to select a media content from the media storing module according to the information about the viewers from the identifying module; and
a displaying unit to display the selected media content.

2. The media displaying system of claim 1, wherein the image capture unit is a camera.

3. The media displaying system of claim 1, further comprising a network unit, wherein the storage system is coupled to the image capture unit and the displaying unit via the network unit.

4. The media displaying system of claim 1, wherein the displaying unit is an electronic billboard.

5. The media displaying system of claim 1, wherein the information about the viewers comprises age and gender of the viewers.

6. A video monitoring system comprising:
an image capture unit to capture a plurality of viewer images;
a processing unit; and
a storage system connected to the processing unit and storing one or more programs to be executed by the processing unit, wherein the storage system comprises:
an image storing module to store the plurality of viewer images from the image capture unit;
a detecting module to examine each of the plurality of viewer images to find faces in each viewer image and identify characteristics of each found face;
a characteristic storing module to store a plurality of face characteristics and information associated with the face characteristics; and
an identifying module to determine information about viewers according to the characteristic storing module and the detecting module.

7. The video monitoring system of claim 6, wherein the image capture unit is a camera.

8. The video monitoring system of claim 6, further comprising a network unit, wherein the storage system is coupled to the image capture unit via the network unit.

9. The video monitoring system of claim 6, wherein the information about the viewers comprises age and gender of the viewers.

10. A media displaying method comprising:
capturing a plurality of viewer images;
examining each of the plurality of viewer images to find faces in each viewer image and identify characteristics of each found face;
determining information about viewers according to the characteristics of each found face in each viewer image, face characteristics, and information associated with the face characteristics, wherein the face characteristics and information associated with the face characteristics are stored in a storage system;
selecting one of media content from the storage system according to the information about the viewers;
transmitting the selected media content to a displaying unit; and
displaying the selected media content by the displaying unit.

11. The media displaying method of claim 10, wherein the displaying unit is an electronic billboard.

12. The media displaying method of claim 10, wherein the information about the viewers comprises age and gender of the viewers.
